(19) United States
(12) Patent Application Publication
(10) Pub. No.: US 2007/0130426 A1
(43) Pub. Date: Jun. 7, 2007

(54) Cache system and shared secondary cache with flags to indicate masters

(75) Inventor: Hiroyuki Utsumi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/377,208

(22) Filed: Mar. 17, 2006

(30) Foreign Application Priority Data
Dec. 5, 2005 (JP) 2005-350977

(51) Int. Cl. G06F 12/00

(52) U.S. Cl. 711/130

(57) ABSTRACT

A cache system includes a plurality of processing units operative to access a main memory device, a plurality of primary caches respectively coupled to the processing units, the primary caches accessible from the processing units at higher speed than the main memory device is accessible from the processing units, and a shared secondary cache coupled to the processing units via the respective primary caches, the shared secondary cache accessible from the processing units at higher speed than the main memory device is accessible from the processing units, wherein the shared secondary cache includes a memory unit configured to store a plurality of entries and, and a set of flags provided separately for each one of the entries, the flags of each set provided in one-to-one correspondence to the processing units, wherein the flags corresponding to a given entry indicate whether the corresponding processing units are using the given entry.

### CROSS-REFERENCE TO RELATED APPLICATIONS

The present application is based upon and claims the benefit of priority from the prior Japanese Patent Application No. 2005-350977 filed on Dec. 5, 2005, with the Japanese Patent Office, the entire contents of which are incorporated herein by reference.

### BACKGROUND OF THE INVENTION

1. Field of the Invention

The present invention generally relates to cache systems, and particularly relates to a cache system in which a cache memory hierarchy is implemented and also to a shared secondary cache used in such a cache system.

2. Description of the Related Art

In computer systems, generally, a cache memory that is smaller in capacity and faster than the main memory is provided in addition to the main memory. Part of the information stored in the main memory is copied to the cache. When this information needs to be accessed, a faster retrieval of information is attained by reading the information from the cache rather than from the main memory.

The cache contains a plurality of cache lines, and the copying of information from the main memory to the cache is performed on a cache-line-specific basis. The memory space of the main memory is divided in units of cache lines. The divided memory segments are sequentially assigned to the cache lines. Since the volume of the cache is smaller than the volume of the main memory, the memory segments of the main memory are repeatedly assigned to the same cache lines.

When a first access is performed with respect to a given address in memory space, information (data or program) stored at this address is copied to a corresponding cache line provided in the cache. When a next access is performed with respect to the same address, the information is retrieved directly from the cache. In general, a predetermined number of lower-order bits of an address serve as an index for caching, and the remaining higher-order bits serve as a cache tag.

When data is to be accessed, the index portion of the address to be accessed is used to read the tag of a corresponding index provided in the cache. A check is then made as to whether the retrieved tag has a matching bit pattern with the tag portion of the address. If there is no match, a cache miss is detected. If there is a match, the cache data (data of a predetermined number of bits equal in size to one cache line) corresponding to this index is accessed.

A cache configuration in which only one tag is provided for each cache line is called a direct mapping system. A cache configuration in which N tags are provided for each cache line is called an N-way set-associative system. The direct mapping system can be regarded as a one-way set-associative system.

A write-through method writes data to the main memory in addition to writing the data to the cache when the data needs to be stored in memory. In this method, it suffices to reset a valid bit indicative of the validity/invalidity of data when there is a need to replace the contents of the cache. On the other hand, a write-back method writes data only to the cache when the data needs to be stored in memory. Since the written data only exists in the cache memory, the contents of the cache memory need to be copied to the main memory when the contents of the cache are to be replaced.

A system in which a cache memory hierarchy is implemented is used for the purpose of reducing a penalty associated with accessing the main memory when a cache miss occurs. A secondary cache that is accessible at faster speed than the main memory may be provided between the primary cache and the main memory.

With this configuration, it is possible to lower the frequency of occurrences that the access to the main memory becomes necessary upon the occurrence of a cache miss at the primary cache, thereby reducing a cache miss penalty. In the description that follows, a two-layer cache system will be examined. A cache that is closer to the processing unit (computing unit) is referred to as a primary cache, and the other cache that is closer to the main memory is referred to as a secondary cache. In general, the primary cache is smaller in capacity and faster, and the secondary cache is larger in capacity and slower.

In a multi-layered cache system, an inclusive cache method offers the simplest configuration as a data inclusive relation between the caches. In the inclusive cache method, all the contents stored in the primary cache are also stored in the secondary cache without exception. That is, the contents of the secondary cache include the contents of the primary cache. This is the simplest configuration, and brings about an advantage in that the control logic for the control of cache operations can be readily constructed. Other methods include an exclusive cache method in which all the cache contents are stored only in one of the primary cache and the secondary cache. The exclusive cache method offers an advantage in which the effective cache capacity is equal to the total cache capacity, which means that a memory utilization rate is high. In the following description of cache operations, the inclusive cache method is used unless indicated to the contrary.

In a system in which a plurality of processing units (masters) are present, provision is often made such that each of the masters has a dedicated primary cache while the secondary cache is shared by the plurality of masters. In such a configuration, the primary caches may be implemented such as to be embedded in the respective masters while the plurality of masters are connected to the shared secondary memory. The masters are coupled to the main memory device via the shared secondary cache.

This configuration in which the secondary cache is shared offers an advantage in that the memory capacity of the secondary cache can be more efficiently utilized, compared with the configuration in which a dedicated secondary cache is provided for each master. Since the plurality of masters share the secondary cache, however, the control of the primary caches and secondary cache becomes undesirably complicated.

In respect of the configuration in which the secondary cache is shared, a control system may be used that does not provide the ID or the like of each master in the secondary cache, and that does not identify a master using an entry with respect to any entry of the secondary cache. When this control system is used, and a given entry is invalidated in the shared secondary cache, a corresponding entry needs to be invalidated in every single one of the masters. Since an invalidating operation performed with respect to the shared secondary cache affects all the masters, a problem arises in that the processing performance of the system drops.

In order to obviate the above problem, provision may be made to provide a copy of the tags of the primary cache in the shared secondary cache with respect to each one of the masters. When a given entry is invalidated in the shared secondary cache, the tag of this entry is searched for in the copies of the tags of the primary caches, thereby identifying one or more primary caches that have an entry corresponding to the invalidated entry. It then suffices to perform an invalidating operation only with respect to the identified primary caches. This achieves an efficient process. When such a configuration is employed, however, a copy of the tags of a primary cache needs to be provided in the shared secondary cache with respect to every single one of the masters. This results in an increase in circuit scale, and also gives rise to a problem in that the control becomes complicated because of the need to search in the tag copies.

Patent Document 1 discloses a configuration that registers a job ID and invalidates an entry by identifying the job ID after the completion of the job.

[Patent Document 1] Japanese Patent Application Publication No. 11-25936

[Patent Document 2] Japanese Patent Application Publication No. 8-305633

Accordingly, there is a need for a shared secondary cache and cache system that can keep a drop in system performance and an increase in circuit size to a necessary minimum.

### SUMMARY OF THE INVENTION

It is a general object of the present invention to provide a shared secondary cache and cache system that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a shared secondary cache and cache system particularly pointed out in the specification in such full, clear, concise, and exact terms as to enable a person having ordinary skill in the art to practice the invention.

To achieve these and other advantages in accordance with the purpose of the invention, the invention provides a cache system, which includes a plurality of processing units operative to access a main memory device, a plurality of primary caches respectively coupled to the processing units, the primary caches accessible from the processing units at higher speed than the main memory device is accessible from the processing units, and a shared secondary cache coupled to the processing units via the respective primary caches, the shared secondary cache accessible from the processing units at higher speed than the main memory device is accessible from the processing units, wherein the shared secondary cache includes a memory unit configured to store a plurality of entries and, and a set of flags provided separately for each one of the plurality of entries, the flags of each set provided in one-to-one correspondence to the processing units, wherein the flags corresponding to a given entry indicate whether the corresponding processing units are using the given entry.

According to another aspect of the present invention, a shared secondary cache connected to a plurality of masters each including a primary cache and serving as an intervening unit between the plurality of masters and a main memory device includes a memory unit configured to store a plurality of entries, and a set of flags provided separately for each one of the plurality of entries, the flags of each set provided in one-to-one correspondence to the masters, wherein the flags corresponding to a given entry indicate whether the corresponding masters are using the given entry.

According to at least one embodiment of the present invention, a set of the identifying flags is provided separately for each entry of the shared secondary cache, thereby making it possible to indicate whether a given entry is being used with respect to each one of the processing units (masters). When a master is specified, therefore, it is easy to identify the entry used by this master. By the same token, when an entry is specified, it is easy to identify the master using this entry. In this configuration, the flags provided for a corresponding entry may store one-bit information with respect to each master. Compared with a configuration in which a copy of the tags of each master is maintained in the shared secondary cache, thus, an increase in circuit size can be reduced.

In this configuration, the flags are checked while successively selecting one of the entries, thereby making it possible to find entries that are being used by a specified master in the shared secondary cache. Invalidating the entries found in this manner in the shared secondary cache makes it possible to perform an entry invalidating process for the specified master readily at high speed. When an entry is invalidated in the shared secondary cache, the corresponding flags are checked so as to readily identify the master(s) using this entry at high speed. By issuing an invalidating request only to the identified masters as described above, an invalidating process can be performed only with respect to the relevant masters without affecting masters unrelated to the entry invalidating process performed at the shared secondary cache.

### BRIEF DESCRIPTION OF THE DRAWINGS

Other objects and further features of the present invention will be apparent from the following detailed description when read in conjunction with the accompanying drawings, in which:

FIG. 1 is a drawing showing the configuration of an embodiment of a cache system according to the present invention;

FIG. 2 is a drawing showing an example of the configuration of an embodiment of a shared secondary cache according to the present invention;

FIG. 3 is a drawing showing the contents of a tag register and a data register in detail;

FIG. 4 is a drawing showing an example of a configuration in which a line address buffer and selector are provided in duplicate;

FIG. 5 is a flowchart showing an example of a cache entry invalidating process according to the present invention;

FIG. 6 is a flowchart showing a first embodiment of the process to invalidate the shared secondary cache;

FIG. 7 is a flowchart showing a second embodiment of the process to invalidate the shared secondary cache; and

FIG. 8 is a drawing showing an example of a configuration in which a line address buffer and selector are provided in duplicate for the purpose of checking master identifying flags.

### DESCRIPTION OF THE PREFERRED EMBODIMENTS

In the following, embodiments of the present invention will be described with reference to the accompanying drawings.

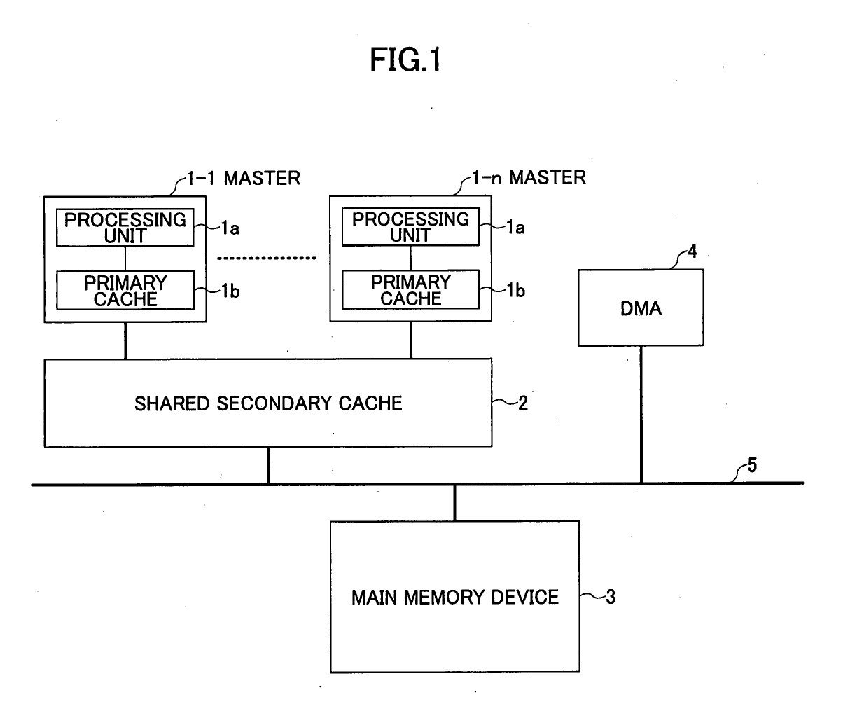

FIG. 1 is a drawing showing the configuration of an embodiment of a cache system according to the present invention. The cache system of FIG. 1 includes a plurality (n) of masters 1-1 through 1-n, a shared secondary cache 2, a main memory device 3, a DMA 4, and a bus 5. Each of the masters 1-1 through 1-n includes a processing unit 1a such as a computing unit that accesses the memory space of the main memory device 3, and also includes a primary cache 1b that is provided between the shared secondary cache 2 and the processing unit 1a.

The masters 1-1 through 1-n shares the shared secondary cache 2, and are coupled to the main memory device 3 via the shared secondary cache 2. The DMA 4 is illustrated only for the sake of convenience of explanation, and is not essential to the cache system of the present invention. The DMA 4, shared secondary cache 2, and main memory device 3 are connected to each other via the bus 5.

In the following, a description will be given of an exemplary operation in which the processing unit 1a of the master 1-1 accesses an address in memory space.

The processing unit 1a of the master 1-1 transmits an address to be accessed to the primary cache 1b of the master 1-1 in order to perform a read/write operation with respect to memory space. In response, a check is made as to whether the data corresponding to this address is stored in the primary cache 1b of the master 1-1. This check is made based on the tag information of the tag register provided in the primary cache 1b. If the data corresponding to the address is stored in the primary cache 1b, the data is supplied from the data register of the primary cache 1b to the processing unit 1a in the case of a read operation. In the case of a write operation, write data supplied from the processing unit 1a replaces the data of the entry that is hit in the primary cache 1b.

If the data corresponding to the address is not stored in the primary cache 1b, a check is made as to whether the data corresponding to the address is stored in the shared secondary cache 2. This check is made based on the tag information of the tag register provided in the shared secondary cache 2. If the data corresponding to the address is stored in the shared secondary cache 2, the data is supplied from the data register of the shared secondary cache 2 to the master 1-1 in the case of a read operation. The data is then registered in the primary cache 1b of the master 1-1. Namely, the data is stored in the data register of the primary cache 1b, and, also, the corresponding tag is stored in the tag register of the primary cache 1b. Further, the corresponding valid bit is set. In the case of a write operation, write data supplied from the processing unit 1a replaces the data of the entry that is hit in the shared secondary cache 2.

If neither the primary cache 1b nor the shared secondary cache 2 has the data corresponding to the address stored therein, the data stored at the address is retrieved from the main memory device 3 via the bus 5 to be copied to the corresponding cache line of the caches. Namely, the data read from the main memory device 3 is registered both in the shared secondary cache 2 and in the primary cache 1b of the master 1-1. In the case of a read operation, the processing unit 1a loads the supplied data. In the case of a write operation, the processing unit 1a replaces the data that is copied to the cache.

In the case of a write operation, if the write-through method is employed, data is written to the main memory device 3 in addition to being written to the primary cache 1b and/or shared secondary cache 2 at the time of data writing. In this method, it suffices to reset a valid bit indicative of the validity/invalidity of data when there is a need to replace the contents of the cache. If the write-back method is employed, on the other hand, data is written only to the primary cache 1b and/or shared secondary cache 2 at the time of data writing. Since the written data only exists in the cache memory, the contents of the cache memory need to be copied to the main memory device 3 when the contents of the cache are to be replaced. In this case, one-bit information referred to as a “dirty bit” that is set in the tag register portion is utilized for the purpose of indicating whether the content of the cache matches the content of the main memory device 3.

The present invention is predicated on the use of the inclusive cache method by which all the contents stored in the primary cache are also included in the secondary cache. As for the data write method, either the write-through method or the write-back method may be used. The following description will be given with respect to an example in which the write-through method is used, for the sake of convenience of explanation.

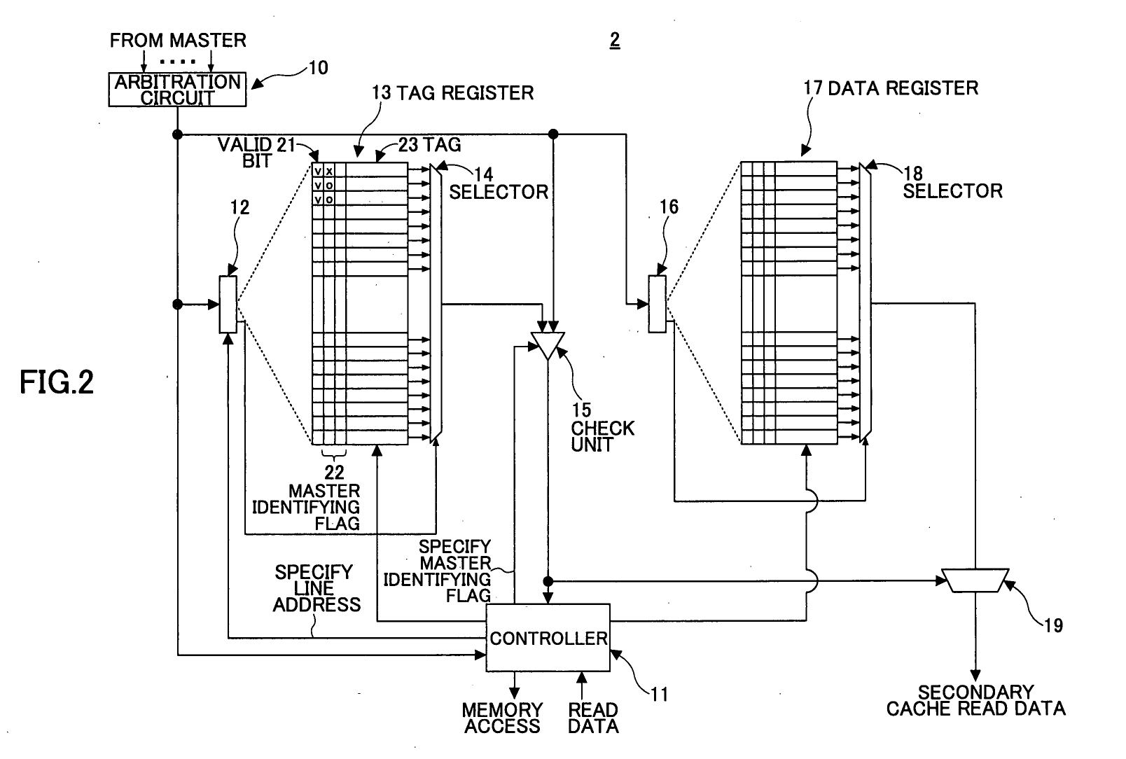

FIG. 2 is a drawing showing an example of the configuration of an embodiment of the shared secondary cache 2 according to the present invention. The shared secondary cache 2 of FIG. 2 includes an arbitration circuit 10, a controller 11, a line address buffer 12, a tag register 13, a selector 14, a check unit 15, a line address buffer 16, a data register 17, a selector 18, and a gate 19. The tag register 13 stores a valid bit 21, master identifying flags 22, and a tag 23 for each entry. Only two master identifying flags 22 are shown for the sake of convenience of illustration. In reality, however, the master identifying flags 22 are provided as many as there are masters (n in the example of FIG. 1) sharing the shared secondary cache 2.

The arbitration circuit 10 is provided for the purpose of selecting a high-priority master when the requests to access the shared secondary cache 2 are received from two or more of the masters 1-1 through 1-n. Upon selecting one of the masters 1-1 through 1-n, the arbitration circuit 10 outputs the access address associated with the request of the selected master. Among all the bits of the access address, the index portion is stored in the line address buffer 12. The selector 14 selects and outputs the content of the tag register 13 corresponding to the relevant index in response to the value stored in the line address buffer 12. The check unit 15 then checks whether the tag output from the selector 14 and the tag portion of the address supplied from the arbitration circuit 10 have a matching bit pattern. If the result of the comparison indicates a match, and the valid bit 21 of the relevant index of the tag register 13 is “1” indicative of the valid status, the check unit 15 asserts its output.

Among all the bits of the access address output from the arbitration circuit 10, the index portion is stored in the line address buffer 16. The selector 18 selects and outputs the data of the data register 17 corresponding to the relevant index in response to the value stored in the line address buffer 16. The data output from the selector 18 is supplied to the master as read data from the shared secondary cache when the gate 19 opens in response to the assertion of the output of the check unit 15.

If the desired data does not exist in the shared secondary cache 2, the output of the check unit 15 is not asserted. In this case, the controller 11 responds to the address supplied from the arbitration circuit 10 by accessing this address in the main memory device 3. The controller 11 loads the data read from the main memory device 3, and registers the data as an entry in the shared secondary cache 2. Namely, the data is stored in the data register 17, and the corresponding tag is stored in the tag register 13. Further, the corresponding valid bit is set.

The controller 11 performs various control operations relating to the cache management. For example, the controller 11 serves to make a setting to a valid bit, to make a tag setting, to search for an available cache line by checking the valid bits, to select a cache line to be replaced according to the LRU (Least Recently Used) algorithm or the like, and to control a data write operation with respect to the data register 17.

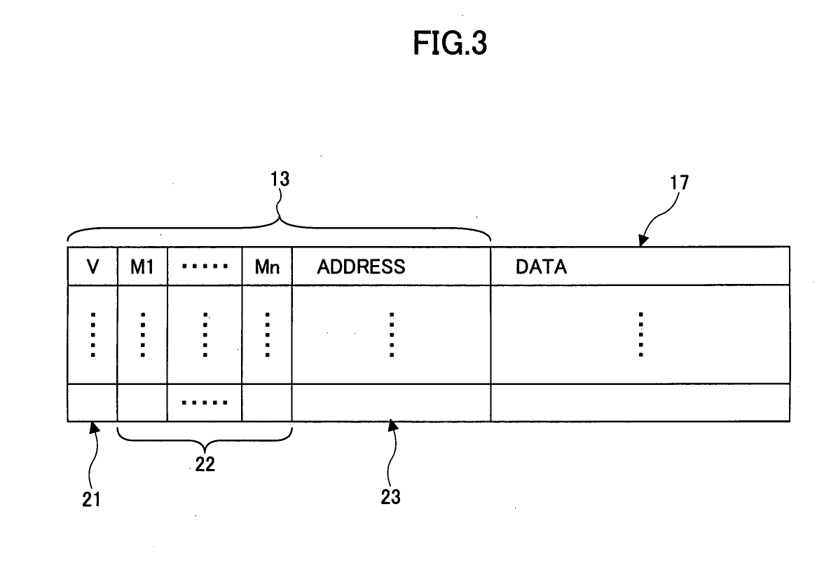

In contrast with the related-art configuration, the shared secondary cache 2 of the present invention is characterized in that the master identifying flags 22 are provided in the tag register 13. FIG. 3 is a drawing showing the contents of the tag register 13 and data register 17 in detail.

As shown in FIG. 3, the tag register 13 includes the valid bit (V) 21, the master identifying flags (M1 through Mn) 22, and the tag (address tag portion) 23 for each entry. The valid bit 21 is one-bit data indicative of the valid/invalid status of the data. The master identifying flags 22 are flags M1 through Mn that are provided in one-to-one correspondence to the masters 1-1 through 1-n shown in FIG. 1. Each flag is one-bit data, which indicates whether the data of the corresponding entry is being used by the corresponding master.

If the master identifying flag M1 of a given data entry (given index) is “0”, this means that this data entry is not being used by the master 1-1 corresponding to the master identifying flag M1. Conversely, if the master identifying flag M1 of a given data entry (given index) is “1”, this means that this data entry is being used by the master 1-1 corresponding to the master identifying flag M1. By the same token, if the master identifying flag Mn of a given data entry is “0”, this means that this data entry is not being used by the master 1-n corresponding to the master identifying flag Mn. Conversely, if the master identifying flag Mn of a given data entry is “1”, this means that this data entry is being used by the master 1-n corresponding to the master identifying flag Mn.

Settings to the master identifying flags 22 is made in response to the requests to access the shared secondary cache 2 issued by the masters 1-1 through 1-n. To be specific, when a given master issues an access request to the shared secondary cache 2, the shared secondary cache 2 searches in the tag register 13. If the desired entry is found as a registered entry, the shared secondary cache 2 sends this entry to the requesting master, and the controller 11 sets the master identifying flag 22 corresponding to the requesting master that requested the entry.

If the desired entry is not registered in the shared secondary cache 2, the data retrieved from the main memory device 3 in response to a read request from the shared secondary cache 2 is registered as an entry in the shared secondary cache 2, and is also transmitted to the requesting master. Further, the controller 11 sets the master identifying flag 22 corresponding to the requesting master that requested the entry.

According to the present invention, as described above, a set of the master identifying flags 22 is provided separately for each entry of the tag register 13 in the shared secondary cache 2, thereby making it possible to indicate whether a given entry is being used with respect to each one of the masters 1-1 through 1-n. When a master is specified, therefore, it is easy to identify the entry used by this master. By the same token, when an entry is specified, it is easy to identify the master using this entry.

In this configuration, the master identifying flags 22 provided for a corresponding entry may store one-bit information with respect to each master. Compared with a configuration in which a copy of the tags of each master is maintained in the shared secondary cache, thus, an increase in circuit size can be reduced.

The selection of an entry to be checked and the checking of the values of the master identifying flags 22 of such a selected entry may be performed by the controller 11 and the check unit 15. In FIG. 2, for example, the controller 11 may specify an index (line address) for the line address buffer 12 so as to indicate an entry to be checked, and the selector 14 selects and outputs the content of the tag register 13 corresponding to this specified entry.

Further, the controller 11 supplies a signal indicative of a master identifying flag to the check unit 15, thereby specifying the flag to be checked. The check unit 15 then checks whether the specified flag contained in the data supplied from the selector 14 is “1” or “0”, followed by supplying the check result to the controller 11.

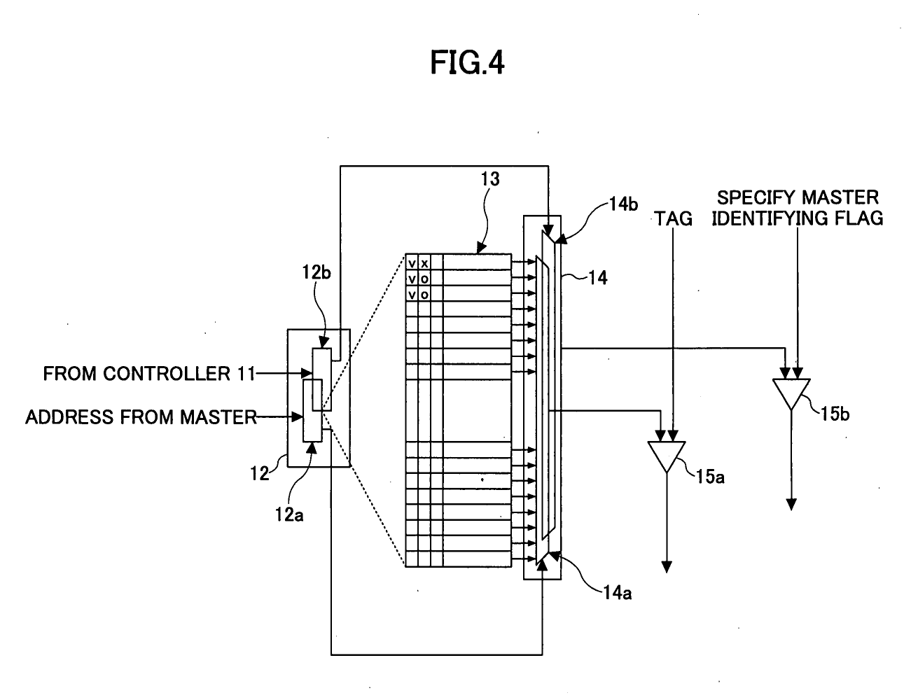

Provision may be made such that a set of the line address buffer 12 and the selector 14 is provided in duplicate, thereby providing a path for cache access from the masters through the arbitration circuit 10 separately from a path for the checking of the values of the master identifying flags 22. FIG. 4 is a drawing showing an example of a configuration in which a line address buffer and selector are provided in duplicate.

In FIG. 4, the line address buffer 12 includes line address buffers 12a and 12b, and the selector 14 includes selectors 14a and 14b. In accordance with this configuration, the check unit 15 is illustrated as including a check unit 15a and a check unit 15b.

The line address buffer 12a, the selector 14a, and the check unit 15a constitute a path used for the purpose of checking whether data corresponding to an address is kept as an entry in response to the address supplied from one of the masters. By using this path, a check is made as to whether the shared secondary cache 2 produces a hit according to the operations previously described when one of the masters 1-1 through 1-n performs a memory access.

The line address buffer 12b, the selector 14b, and the check unit 15b constitute a path used for the purpose of checking whether an entry corresponding to a specified line address is being used by a specified master in response to the specified line address and specified master identifying flag supplied from the controller 11. Namely, the controller 11 may specify an index (line address) for the line address buffer 12b so as to indicate an entry to be checked, and the selector 14bselects and outputs the content of the tag register 13 corresponding to this specified entry. Further, the controller 11 supplies a signal indicative of a master identifying flag to the check unit 15b, thereby specifying the flag to be checked. The check unit 15b then checks whether the specified flag contained in the data supplied from the selector 14b is “1” or “0”, followed by outputting the check result.

With the provision of the path for cache access from a master and the path for the checking (searching) of a master identifying flag as separate paths, it is possible to perform simultaneously an invalidating process to invalidate an entry of the shared secondary cache 2 and an access request supplied from a master to the shared secondary cache 2. This makes it possible to perform an invalidating request issued from a given master without affecting a process for another master.

In the following, a description will be given of the operation to invalidate an entry in the embodiment of the cache system of the present invention shown in FIG. 1. As a specific example, a description will be given of a case in which the DMA 4 (FIG. 1) replaces an area used by the master 1-1 (hereinafter referred to as M1) among the masters 1-1 through 1-n.

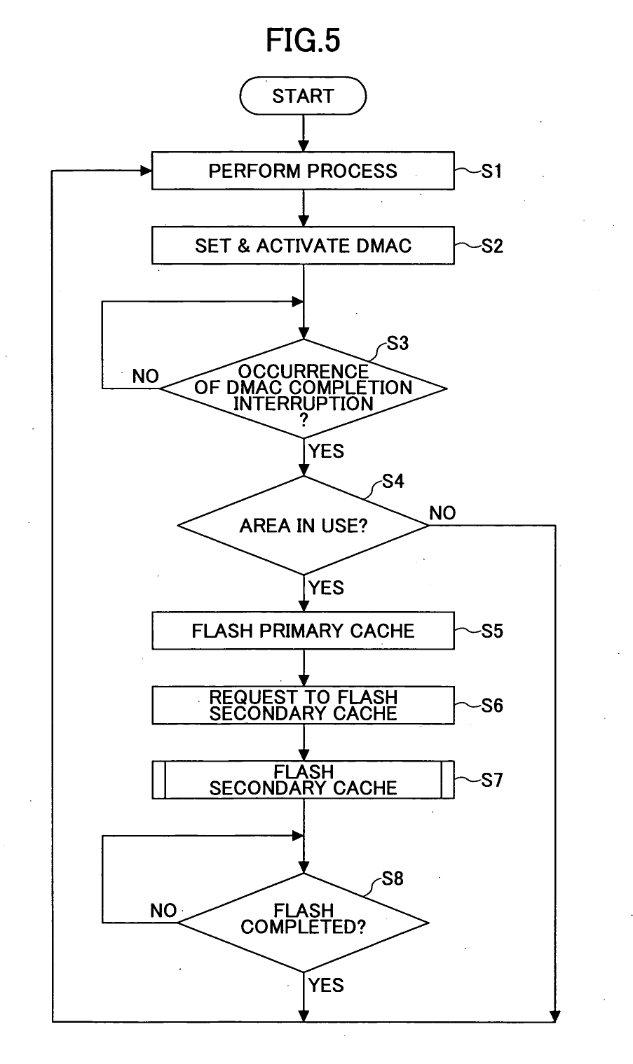

FIG. 5 is a flowchart showing an example of the cache entry invalidating process according to the present invention.

At step S1, M1 performs any given process by which an area A of the main memory device 3 is accessed, resulting in the content of the area A being stored in the shared secondary cache 2 and in the primary cache 1b of M1. At step S2, M1 makes settings to the DMAC to specify information necessary for DMA transfer, followed by instructing the DMAC to start data transfer.

At step S3, a check is made as to whether a DMAC completion interruption occurs. Upon the completion of the transfer, the DMAC issues a DMA transfer completion interruption to M1 that has initiated the transfer. When the interruption occurs, the procedure proceeds to step S4.

At step S4, having received the interruption notice, M1 activates an interruption process routine so as to check whether the area rewritten by the DMA transfer includes the area A used by M1. If the area A is not included, the procedure returns to step S1, at which the process being performed by M1 resumes.

If it is ascertained that the area A being used by M1 is rewritten, at step S5, the primary cache 1b provided inside M1 is flashed (i.e., all the contents of the primary cache 1b are invalidated). At step S6, further, M1 issues an invalidating request to the shared secondary cache 2 so as to invalidate the entries being used by M1 in the shared secondary cache 2. These invalidating processes are necessary because data stored in the main memory device 3 and data stored in each cache are not consistent any longer with respect to the area A.

At step S7, the shared secondary cache 2 is flashed. Namely, all the entries being used by M1 in the shared secondary cache 2 are invalidated. During the time in which the shared secondary cache is being flashed, a request from M1 is kept on hold.

At step S8, a check is made as to whether the flashing of the shared secondary cache is completed. When the flashing of the shared secondary cache is completed, the procedure returns to step S1, at which the process being performed by M1 resumes.

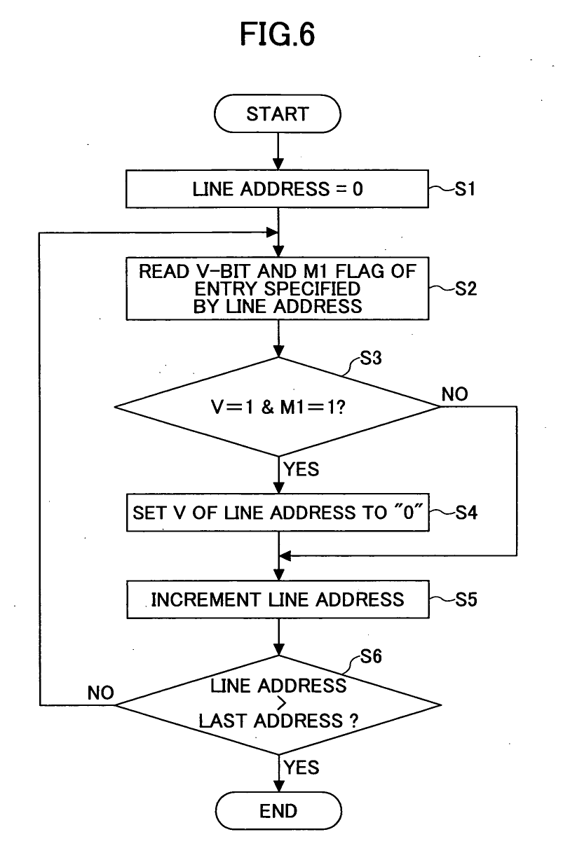

FIG. 6 is a flowchart showing a first embodiment of the process to invalidate the shared secondary cache 2. The process of this flowchart is performed at step S7 of FIG. 5, and is directed to an example in which the area A rewritten by the DMAC is an area only used by M1.

The shared secondary cache 2 receives the request from M1 to invalidate the entries being used by M1. In response, at step S1, the controller 11 sets the line address of the line address buffer 12 to zero.

At step S2, the selector 14 selectively reads the content of the tag register 13 with respect to an entry specified by the line address (index) of the line address buffer 12. This content includes the valid bit 21 and the master identifying flags 22. At step S3, the check unit 15 checks whether the value V of the retrieved valid bit 21 is “1” (valid) and also one of the retrieved master identifying flags 22 corresponding to M1 is “1” (being used). The procedure proceeds to step S5 unless the entry is valid and being used by M1. If the entry is valid and being used by M1, at step S4, the controller 11 sets the value V of the valid bit 21 corresponding to the line address to zero, thereby invaliding this entry. At step S5, the controller 11 increments the line address of the line address buffer 12 by one.

At step S6, a check is made as to whether the line address after the increment exceeds the last address. If the address has not exceeded the last address, the procedure returns to step S2, from which the subsequent steps are repeated. If the line address after the increment exceeds the last address, the procedure comes to an end. Upon the end of the procedure shown in FIG. 6, the shared secondary cache 2 reports this to M1.

In this manner, the master identifying flags 22 are checked while successively incrementing the line address, thereby searching for entries that are being used by a specified master in the shared secondary cache 2. Invalidating the entries found in this manner in the shared secondary cache 2 makes it possible to perform an entry invalidating process for the specified master readily at high speed.

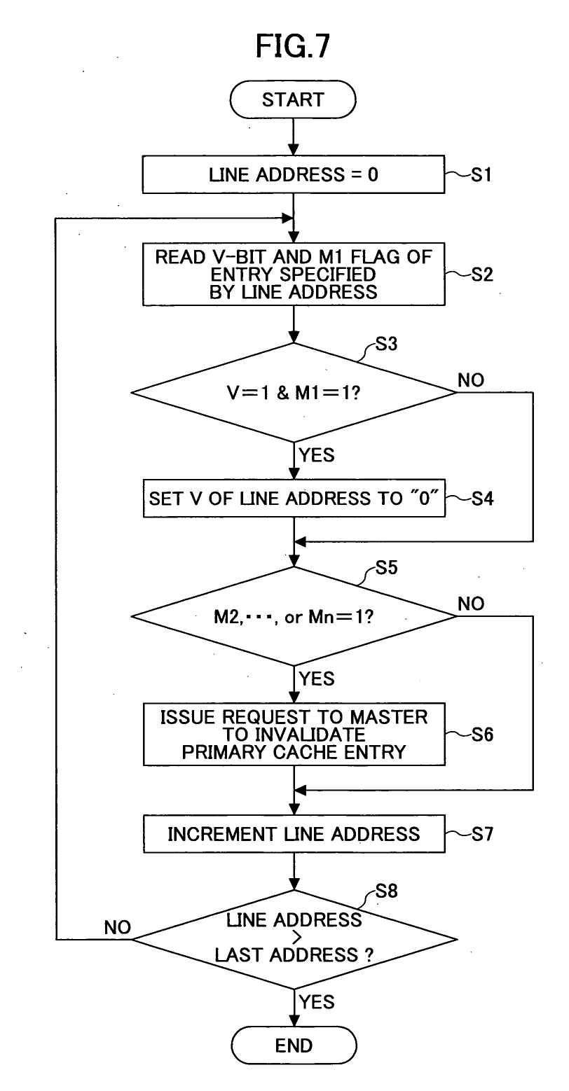

FIG. 7 is a flowchart showing a second embodiment of the process to invalidate the shared secondary cache 2.

The process of this flowchart is performed at step S7 of FIG. 5, and is directed to an example in which the area A rewritten by the DMAC is an area that is also used by one or more of the masters 1-1 through 1-n other than M1 (assumed to be M2 in this example).

The shared secondary cache 2 receives the request from M1 to invalidate the entries being used by M1. In response, at step S1, the controller 11 sets the line address of the line address buffer 12 to zero.

At step S2, the selector 14 selectively reads the content of the tag register 13 with respect to an entry specified by the line address (index) of the line address buffer 12. This content includes the valid bit 21 and the master identifying flags 22. At step S3, the check unit 15 checks whether the value V of the retrieved valid bit 21 is “1” (valid) and also one of the retrieved master identifying flags 22 corresponding to M1 is “1” (being used). The procedure proceeds to step S5 unless the entry is valid and being used by M1. If the entry is valid and being used by M1, at step S4, the controller 11 sets the value V of the valid bit 21 corresponding to the line address to zero, thereby invaliding this entry.

After this, at step S5, a check is made as to whether any of the retrieved master identifying flags 22 is “1” with respect to M2 through Mn other than M1. This check may be made by the check unit 15 (or check unit 15b). When none of the flags is “1”, the procedure proceeds to step S7. If any one of the flags is “1”, the procedure proceeds to step S6.

At step S6, the controller 11 issues an invalidating request to invalidate an entry in the primary cache 1b with respect to the master(s) for which the corresponding flag(s) is found to be “1” by the check at step S5. With this provision, the entry of the primary cache 1b at the line address corresponding to the current line address (index) stored in the line address buffer 12 of the shared secondary cache 2 is invalidated in the master(s) (M2 in this example) to which the invalidating request is issued.

At step S7, the controller 11 increments the line address of the line address buffer 12 by one. At step S8, a check is made as to whether the line address after the increment exceeds the last address. If the address has not exceeded the last address, the procedure returns to step S2, from which the subsequent steps are repeated. If the line address after the increment exceeds the last address, the procedure comes to an end. Upon the end of the procedure shown in FIG. 7, the shared secondary cache 2 reports this to M1.

In this manner, when an entry is invalidated in the shared secondary cache 2, the corresponding master identifying flags 22 are checked so as to readily identify the master(s) using this entry at high speed. By issuing an invalidating request only to the identified masters as described above, an invalidating process can be performed only with respect to the relevant masters without affecting masters unrelated to the entry invalidating process performed at the shared secondary cache 2.

The example described above is directed to a case in which an invalidating request is supplied only from one master M1 to the shared secondary cache 2. In actuality, however, there may be a case in which two or more of the masters 1-1 through 1-n simultaneously request an invalidating process to the shared secondary cache 2. In consideration of such a scenario, it is preferable to provide multiple paths for checking (searching for) master identifying flags, thereby allowing invalidating requests from two or more masters to be processed simultaneously.

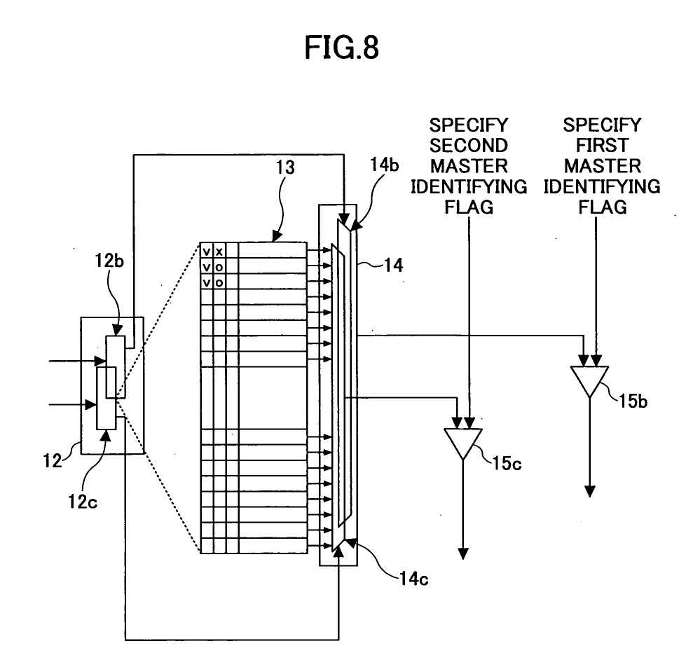

FIG. 8 is a drawing showing an example of a configuration in which a line address buffer and selector are provided in duplicate for the purpose of checking the master identifying flags.

In FIG. 8, the line address buffer 12 includes line address buffers 12b and 12c. These line address buffers 12b and 12c are provided separately from the line address buffer 12a (see FIG. 4). Further, the selector 14 includes selectors 14b and 14c. These selectors 14b and 14c are provided separately from the selector 14a (see FIG. 4). In accordance with this configuration, the check unit 15 is illustrated as including a check unit 15b and a check unit 15c.

The line address buffer 12b, the selector 14b, and the check unit 15b constitute a first path used for the purpose of checking whether an entry corresponding to a specified line address is being used by a specified master in response to the specified line address and specified master identifying flag supplied from the controller 11. The controller 11 may specify an index (line address) for the line address buffer 12b so as to indicate an entry to be checked, and the selector 14b selects and outputs the content of the tag register 13 corresponding to this specified entry. Further, the controller 11 supplies a signal indicative of a master identifying flag to the check unit 15b, thereby specifying the flag to be checked. The check unit 15b then checks whether the specified flag contained in the data supplied from the selector 14b is “1” or “0”, followed by outputting the check result.

By the same token, the line address buffer 12c, the selector 14c, and the check unit 15c constitute a second path used for the purpose of checking whether an entry corresponding to a specified line address is being used by a specified master in response to the specified line address and specified master identifying flag supplied from the controller 11.

With the provision of the multiple paths for checking (searching for) master identifying flags as separate paths, it is possible to perform simultaneously a first invalidating process to invalidate an entry of the shared secondary cache 2 in response to a request from a first master and a second invalidating process to invalidate an entry of the shared secondary cache 2 in response to a request from a second master. This makes it possible to efficiently process invalidating requests issued from masters.

Further, the present invention is not limited to these embodiments, but various variations and modifications may be made without departing from the scope of the present invention.

What is claimed is:

1. A cache system, comprising:
a plurality of processing units operative to access a main memory device;
a plurality of primary caches respectively coupled to the processing units, the primary caches accessible from the processing units at higher speed than the main memory device is accessible from the processing units; and
a shared secondary cache coupled to the processing units via the respective primary caches, the shared secondary cache accessible from the processing units at higher speed than the main memory device is accessible from the processing units,
wherein the shared secondary cache includes:
a memory unit configured to store a plurality of entries and; and
a set of flags provided separately for each one of the plurality of entries, the flags of each set provided in one-to-one correspondence to the processing units,
wherein the flags corresponding to a given entry indicate whether the corresponding processing units are using the given entry.

2. The cache system as claimed in claim 1, wherein the shared secondary cache further includes a controller configured to select one of the entries one after another and to refer to a specified one of the flags corresponding to the selected entry, thereby searching for an entry that is being used by one of the processing units corresponding to the specified flag.

3. The cache system as claimed in claim 2, wherein the shared secondary cache further includes:
a first circuit configured to select one of the entries in response to an access request supplied from one of the processing units; and
a second circuit configured to select one of the entries one after another for entry search by the controller,
wherein the first circuit and the second circuit are provided separately, and are independently operable.

4. The cache system as claimed in claim 3, wherein the shared secondary cache further includes a third circuit configured to select one of the entries one after another for entry search by the controller, wherein the second circuit and the third circuit are provided separately, and are independently operable.

5. The cache system as claimed in claim 1, wherein the shared secondary cache includes a controller configured to set a flag to a value indicative of an in-use status, the flag being corresponding to one of the processing units and being one of the flags that correspond to one of the entries accessed by said one of the processing units.

6. A shared secondary cache connected to a plurality of masters each including a primary cache and serving as an intervening unit between the plurality of masters and a main memory device, comprising:
a memory unit configured to store a plurality of entries; and
a set of flags provided separately for each one of the plurality of entries, the flags of each set provided in one-to-one correspondence to the masters,
wherein the flags corresponding to a given entry indicate whether the corresponding masters are using the given entry.

7. The shared secondary cache as claimed in claim 6, further comprising a controller configured to select one of the entries one after another and to refer to a specified one of the flags corresponding to the selected entry, thereby searching for an entry that is being used by one of the maters corresponding to the specified flag.

8. The shared secondary cache as claimed in claim 7, further comprising:
a first circuit configured to select one of the entries in response to an access request supplied from one of the masters; and
a second circuit configured to select one of the entries one after another for entry search by the controller,
wherein the first circuit and the second circuit are provided separately, and are independently operable.

9. The shared secondary cache as claimed in claim 8, further comprising a third circuit configured to select one of the entries one after another for entry search by the controller, wherein the second circuit and the third circuit are provided separately, and are independently operable.

10. The shared secondary cache as claimed in claim 6, further comprising a controller configured to set a flag to a value indicative of an in-use status, the flag being corresponding to one of the masters and being one of the flags that correspond to one of the entries accessed by said one of the masters.
